(19) United States
(12) Patent Application Publication
(10) Pub. No.: US 2022/0148430 A1
(43) Pub. Date: May 12, 2022

(54) SHARING TRAVELED PATHWAY DATA

(71) Applicants: Yuju Neo Takahashi, Plano, TX (US); Hanzala Bin Rehan, Plano, TX (US)

(72) Inventors: Yuju Neo Takahashi, Plano, TX (US); Hanzala Bin Rehan, Plano, TX (US)

(21) Appl. No.: 17/521,658

(22) Filed: Nov. 8, 2021

Related U.S. Application Data
(60) Provisional application No. 63/110,927, filed on Nov. 6, 2020.

(51) Int. Cl. G08G 1/16; G08G 1/08; G08G 1/01; G08G 1/017

(52) U.S. Cl. CPC G08G 1/164; G08G 1/166; G08G 1/017; G08G 1/0133; G08G 1/0145; G08G 1/08

(57) ABSTRACT

An example operation may include one or more of configuring a first sensor to capture image data and a second sensor to capture depth data of one or more objects at an intersection, receiving, at a computing system, traffic data comprising the image sensor data, the depth sensor data, and data of a traffic light, determining, by the computing system, a potential accident when a blockage in a field of view of the one or more objects exists from the traffic data, creating, by the computing system, an anomaly report of the potential accident, transmitting, by the computing system, the anomaly report to the one or more objects, and reacting, at the one or more objects, to avoid the potential accident, based on the anomaly report.

### BACKGROUND

Consumer vehicles have computerized control to levy consumer features that include but are not limited to advanced lane-keeping, adaptive cruise control, and other such consumer autonomy features. This is done using sensors including, but not limited to; cameras, radar sensors, LIDAR sensors, and computers throughout the vehicle. Although this is not full autonomy, it makes apparent that if consumer vehicles receive the correct data, they can perform the necessary motor operations needed for safely navigating intersections at L4/L5 self-driving as defined by the U.S Department of Transportation's National Highway Traffic Safety Administration (“NHTSA”).

Intersections and highways may be equipped with hardware which may include but is not limited to image sensors, radar sensors, infrared sensors, and traffic controllers to manage traffic congestion and safety. These hereby technologies enable the modern transportation management solutions we see today.

### SUMMARY

One example embodiment provides a method that includes one or more of configuring a first sensor to capture image data and a second sensor to capture depth data of one or more objects at an intersection, receiving, at a computing system, traffic data comprising the image sensor data, the depth sensor data, and data of a traffic light, determining, by the computing system, a potential accident when a blockage in a field of view of the one or more objects exists from the traffic data, creating, by the computing system, an anomaly report of the potential accident, transmitting, by the computing system, the anomaly report to the one or more objects, and reacting, at the one or more objects, to avoid the potential accident, based on the anomaly report.

Another example embodiment provides a system that includes a memory communicably coupled to a processor, wherein the processor performs one or more of configure a first sensor to capture image data and a second sensor to capture depth data of one or more objects at an intersection, receive, at a computing system, traffic data that comprises the image sensor data, the depth sensor data, and data of a traffic light, determine, by the computing system, a potential accident when a blockage in a field of view of the one or more objects exists from the traffic data, create, by the computing system, an anomaly report of the potential accident, transmit, by the computing system, the anomaly report to the one or more objects, and react, at the one or more objects, to avoid the potential accident, based on the anomaly report.

A further example embodiment provides a non-transitory computer readable medium comprising instructions, that when read by a processor, cause the processor to perform one or more of configuring a first sensor to capture image data and a second sensor to capture depth data of one or more objects at an intersection, receiving, at a computing system, traffic data comprising the image sensor data, the depth sensor data, and data of a traffic light, determining, by the computing system, a potential accident when a blockage in a field of view of the one or more objects exists from the traffic data, creating, by the computing system, an anomaly report of the potential accident, transmitting, by the computing system, the anomaly report to the one or more objects, and reacting, at the one or more objects, to avoid the potential accident, based on the anomaly report.

### BRIEF DESCRIPTION OF THE DRAWINGS

FIG. 1A illustrates a diagram of a Sharing Traveled Pathway Data system, according to example embodiments.

FIG. 1B illustrates a display as viewed inside a transport, according to example embodiments.

FIG. 2A illustrates a transport network diagram, according to example embodiments.

FIG. 2B illustrates another transport network diagram, according to example embodiments.

FIG. 3A illustrates a flow diagram, according to example embodiments.

FIG. 3B illustrates another flow diagram, according to example embodiments.

FIG. 4 illustrates a machine learning transport network diagram, according to example embodiments.

FIG. 5 illustrates an example system that supports one or more of the example embodiments.

### DETAILED DESCRIPTION

It will be readily understood that the instant components, as generally described and illustrated in the figures herein, may be arranged and designed in a wide variety of different configurations. Thus, the following detailed description of the embodiments of at least one of a method, apparatus, non-transitory computer readable medium and system, as represented in the attached figures, is not intended to limit the scope of the application as claimed but is merely representative of selected embodiments.

The instant features, structures, or characteristics as described throughout this specification may be combined in any suitable manner in one or more embodiments. For example, the usage of the phrases “example embodiments”, “some embodiments”, or other similar language, throughout least this specification refers to the fact that a particular feature, structure, or characteristic described in connection with the embodiment may be included in at one embodiment. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments. In the diagrams, any connection between elements can permit one-way and/or two-way communication even if the depicted connection is a one-way or two-way arrow.

In addition, while the term “message” may have been used in the description of embodiments, the application may be applied to many types of network data, such as, packet, frame, datagram, etc. The term “message” also includes packet, frame, datagram, and any equivalents thereof. Furthermore, while certain types of messages and signaling may be depicted in exemplary embodiments they are not limited to a certain type of message, and the application is not limited to a certain type of signaling.

Example embodiments provide methods, systems, components, non-transitory computer readable media, devices, and/or networks, which provide at least one of: a transport (also referred to as a vehicle herein) sensor data collection system, a verification system, and a vehicle data distribution system. The sensor data, received in the form of communication update messages, such as wireless data network communications and/or wired communication messages, may be received, and processed to identify vehicle/transport status conditions and provide safety and optimal transport modification options to assist with vehicle travel.

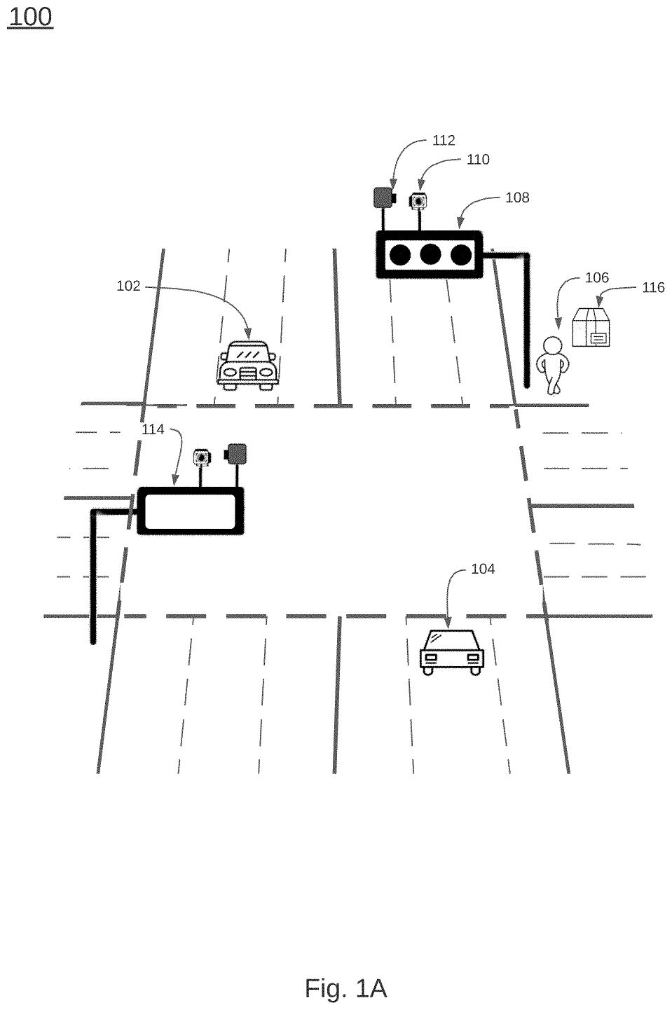

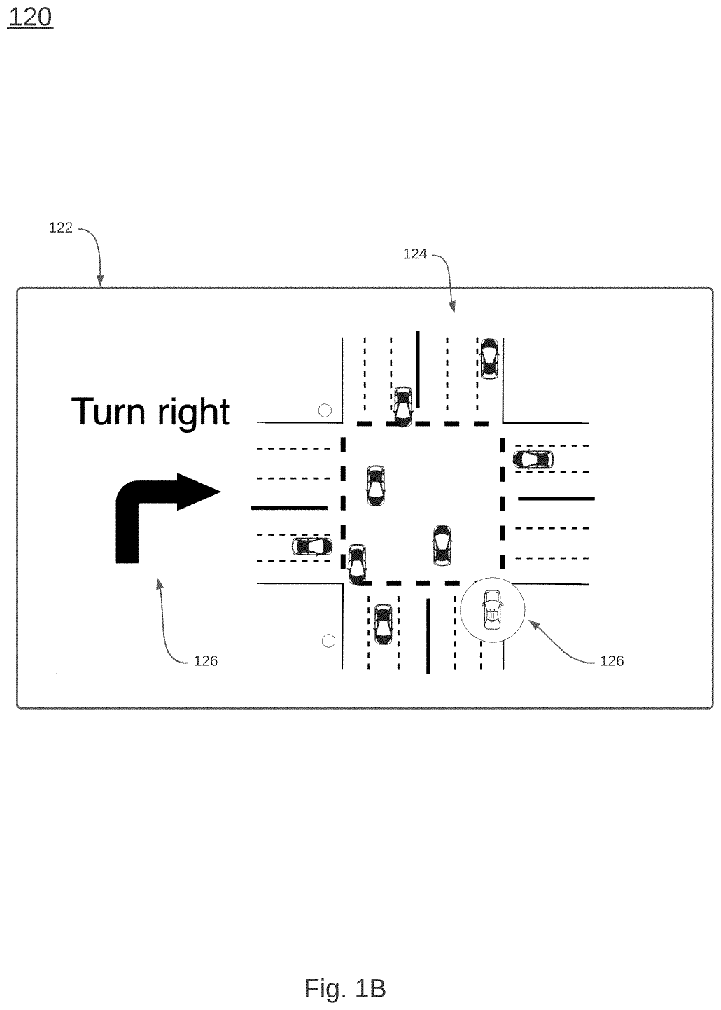

FIG. 1A illustrates a diagram of a Sharing Traveled Pathway Data system 100, according to example embodiments. As an object nears an intersection, the object is identified using vision and depth technologies in capturing devices (110, 112) which may be attached to an object such as a traffic light 108, 114. The capturing device 110, 112 may be angled down towards 110 and away from 112 the intersection. The capturing devices can capture images of objects at the intersection and objects approaching the intersection, which may provide an ability to determine objects that may collide through analysis an projection. The images of the objects are then sent from the capturing devices to a computing device, such as a traveled pathway computing module 116 which may contain a processor executing the current application, in one embodiment.

In one embodiment, the computing device may utilize an algorithm to compensate for latency using predictive measures to generate relevant and live occupancy data of the intersection. The computing device may also send messages to other connected agents (104, 106) to receive the information to aid in efficiently and safely navigating the complexities of the respective intersection. The non-connected agent(s), such as object 102 would not be able to receive the information gathered using the current system, however, the connected agents 104, 106 are able to detect the non-connected agent(s) 102 and will receive information to possibly avoid collisions and accidents pertaining to the non-connected agent(s). The messages delivered to the connected agents may be presented to a display (such as a display of a head unit) in a transport, or a device associated with the connected agent, such as a mobile device.

In one embodiment, vision and depth technologies are utilized in the cameras 110, 112. Depth detection in cameras is widely used and may utilize LIDAR systems to accurately determine depth data from an object in the received media. LIDAR systems fire laser pulses at the objects and measures the time it takes for these pulses to get reflected to the camera. In another embodiment, the LIDAR system may measure the change in wavelength of the laser pulses. In another embodiment, multiple lenses in the camera may be used to determine depth of objects in the media. The depth data may be sent to the computing device as part of the media sent, in one embodiment.

In one embodiment, the capturing devices 110, 112 collect media such as images and/or video. The collected media is sent via a processor in the capturing devices (wired or wirelessly) to a processor in the computing device 116 for processing. The computing device receives media from all angles of the intersection from capture devices 110,112 that may be affixed to traffic lights 108,114, signs, objects near the intersection, and the like. The media is analyzed and overlaid with additional data, in some embodiments, and sent from the computing device 116 to connected agents, such as transports 104, and devices associated with pedestrians 106 such as mobile devices. The media may be broadcast from the computing device 116, uploaded to the cloud or a server in a network via wireless messaging where it is then wirelessly sent to the connected agents 104, 106, utilize a short-range wireless protocol, or the like. The media may help the received objects 104, 106 to see other oncoming objects 102 that may otherwise be blocked from view.

A first sensor 112 is configured by the system to capture image data, where the image data may include still images or images in a video. A second sensor 110 is configured to capture depth data such that it is possible to ascertain the depth of the object in the image data. The first and second sensors may be positioned near an intersection on objects, such as traffic lights 108, 114, or any object near the intersection. The data from the first and second sensors, referred to as traffic data is sent to a processor, such as the processor in the computing device 116. Data from at least one traffic light 108, 114 may be sent to the processor of the computing device. This data, referred to as traffic data is received by the processor of the computing device where it is stored in memory in the computing device. The current application, executing on a processor in the computing device, analyzes the data where a potential accident is determined. The current application projects the trajectory of objects in motion, as determined by the received image and depth data of objects at or approaching the intersection. The current application generates an anomaly report containing a map of the intersection, objects in or near the intersection. The anomaly report may also contain details of possible collisions determined therein. The potential collision may be due to an object (such as a transport in motion) that blocks the view of another transport in motion. The current application transmits the anomaly report to one or more objects, which may be the connected agents at the intersection. In one embodiment, the transport with the potential blockage may receive the anomaly report. Processors in the objects (such as transport processors and/or processors of devices associated with the objects) may display the data in the anomaly report by sending the data to a processor associated with a display in a transport, for example. The objects may avoid a collision when the anomaly report is viewed.

In one embodiment, data from the cameras 110, 112 is received at the computing device 116 where the data is stored and analyzed by one or more of the current application and 3^{rd} party applications executing on the computing device 116. In one embodiment, the analysis includes projecting the trajectories of the one or more objects detected 104, 106, 102 such that it is possible to predict where the respective object will be in an amount of future time, given its current speed and direction. This projection may be overlaid onto a map, such as a 2- or 3-dimensional map. This map is included in an anomaly report generated by the current application. The report is sent from a processor of the computing device 116 to processors of the connected agents 104, 106, which may be a processor in a transport 104 (referred herein to the transport processor) or a processor of a device (such as a mobile device) associated with a pedestrian 106 near the intersection. The transport processor in the connected agent 104 may send the data to a processor associated with a display in the cabin of the transport where the data in the anomaly report is viewable by occupants in the transport 104. The occupants in the transport can view the projected trajectories of objects at or near the intersection that they are unable to see, for example.

In one embodiment, the cameras 110, 112 may detect an object that, when sent to the computing device 116, is unrecognizable. An unrecognized object may be an object (such as rubber from a tire, or the like. The object may be at or near the intersection, for example. The current application may add text and/or manipulations of the image and/or video in the anomaly report to highlight the unrecognized object at or near the intersection. For example, the text, “Unrecognized Object” may be overlaid on the media of the anomaly report, with an arrow pointing to the object, for example. This may assist the occupants of the transports receiving the anomaly reports to be aware of object that may cause a collision, due to the occupants detecting the object with their own eyes.

In one embodiment, a simulation of the traffic flow of the traffic detected by the cameras 110, 112 is generated, such as by the current application executing on a processor in the computing device 116. This simulation may project the objects in the media, according to their current detected depth and motion (including speed and direction). The simulation which may be a generated video. may be part of the anomaly report that is delivered to the connected agent 104, 106 and allow occupants associated with the connected agents to view the simulation video and become aware of possible collisions before they occur.

In one embodiment, a navigable path is determined by the current application executing on a processor in the computing device 116. The navigable path is determined by the current application projecting the objects at the intersection, knowing their current speed and direction, and projecting the future path of the objects. The navigable path may include a recommendation to alter a speed of the transport, such that the transport will avoid a collision with another object at the intersection. This is determined by knowing the current location, speed, and direction of both the transport and the objects one or more of at the intersection and approaching the intersection. In one embodiment, the navigable path and data determined therein is included in the anomaly report sent to the connected objects 104, 106.

In one embodiment, the current application may modify a change of a light 108, 114 to avoid a potential collision. For example, when an object such as a transport at the intersection is turning and the current application, through analysis of received media from the cameras 110, 112, determines that there may be a blind spot and/or a potential collision, the current application may request a modification of a light change. This may be performed by the current application sending a message to the light. The processor in the computing device 116 sends a message to a processor associated with the traffic light 108, 114 including an amount of time to delay the light change, for example. The delay in the light change may provide enough time for the occlusion to dissipate.

FIG. 1B is an illustration 120 of a display 122 inside of a connected agent's vehicle 104. Data is sent from a processor in the computing device 116 to a processor in the connected vehicle 104, such as a transport processor. The transport processor may forward the received data to another processor, such as a processor associated with a display 122 in the transport, wherein the display presents the data 124 which may be viewed by an occupant of the transport. As a connected agent 104 approaches the intersection, the computing device 116 may become aware. This may be through messaging between the connected agent and the computing device including a geographical location of the connected agent. In another embodiment, the computing device may be aware of all connected agents, such that when a connected agent is proximate, the computing device is made aware. For example, the geographical coordinates of the connected agent(s) are compared with the geographical coordinates of the computing device, and when the connected agent(s) are within a minimum radius of the intersection, the current application executing on a processor such as a processor in the computing device 116 may perform functionality. This functionality may be to send data to the connected agent(s), wherein the data may contain current objects (such as transports) at and/or near the intersection. In one embodiment, the connected agent of the display 122 is highlighted on the display 126, such that the observer of the data may be able to easily understand the data. In another embodiment, a command 128 may be presented on the display 122, informing that an action is presumed to be a safe action. The command 128 may present another command, when it is determined that the action is unsafe, such as a “STOP” command.

The command 128 may be determined by a current blinker on the transport, where the current application is aware that an action, such as a right turn, is desired. The current application executing on a processor of the transport, such as the transport processor may be aware of the blinker status of the transport. In another embodiment, the current application may interact with an application executing on the transport, such as a navigation application, where the action 126 may be known.

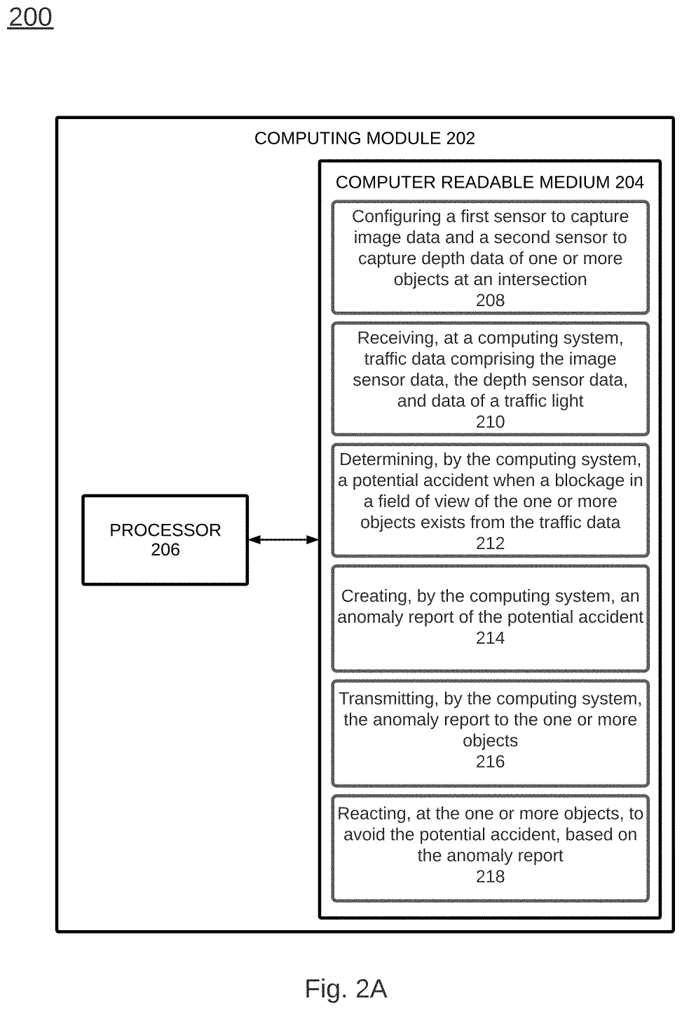

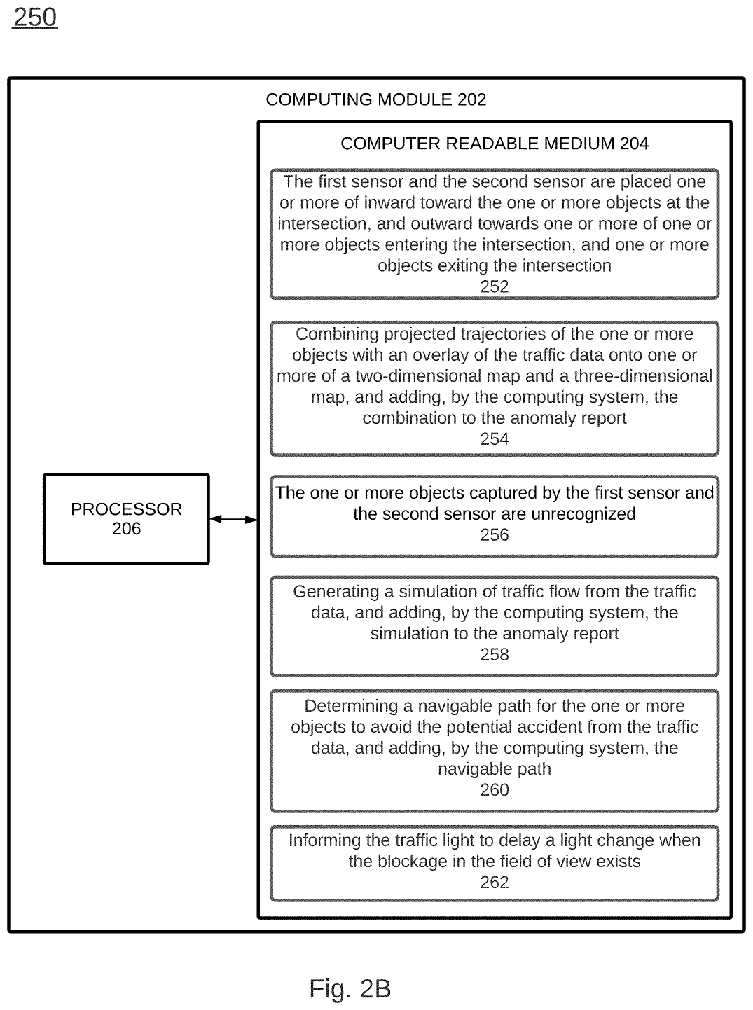

FIG. 2A illustrates a transport network diagram 200, according to example embodiments. The network comprises elements including a computing module 202 including a processor 206 and a non-transitory computer readable medium 204. The processor 206 is communicably coupled to the computer readable medium 204. The computer module 202 could be a transport, server or any device which includes a processor and memory.

The processor 206 performs one or more of configuring a first sensor to capture image data and a second sensor to capture depth data of one or more objects at an intersection 208, receiving, at a computing system, traffic data comprising the image sensor data, the depth sensor data, and data of a traffic light 210, determining, by the computing system, a potential accident when a blockage in a field of view of the one or more objects exists from the traffic data 212, creating, by the computing system, an anomaly report of the potential accident 214, transmitting, by the computing system, the anomaly report to the one or more objects 216, and reacting, at the one or more objects, to avoid the potential accident, based on the anomaly report 218.

FIG. 2B illustrates a transport network diagram 250, according to example embodiments. The network comprises elements including a computing module 202 including a processor 206 and a non-transitory computer readable medium 204. The processor 206 is communicably coupled to the computer readable medium 204. The computer module 202 could be a transport, server or any device which includes a processor and memory.

The processor 206 performs one or more of the first sensor and the second sensor are placed one or more of inward toward the one or more objects at the intersection, and outward towards one or more of one or more objects entering the intersection, and one or more objects exiting the intersection 252, combining projected trajectories of the one or more objects with an overlay of the traffic data onto one or more of a two-dimensional map and a three-dimensional map, and adding, by the computing system, the combination to the anomaly report 254, the one or more objects captured by the first sensor and the second sensor are unrecognized 256, generating a simulation of traffic flow from the traffic data, and adding, by the computing system, the simulation to the anomaly report 258, determining a navigable path for the one or more objects to avoid the potential accident from the traffic data, and adding, by the computing system, the navigable path 260, and informing the traffic light to delay a light change when the blockage in the field of view exists 262.

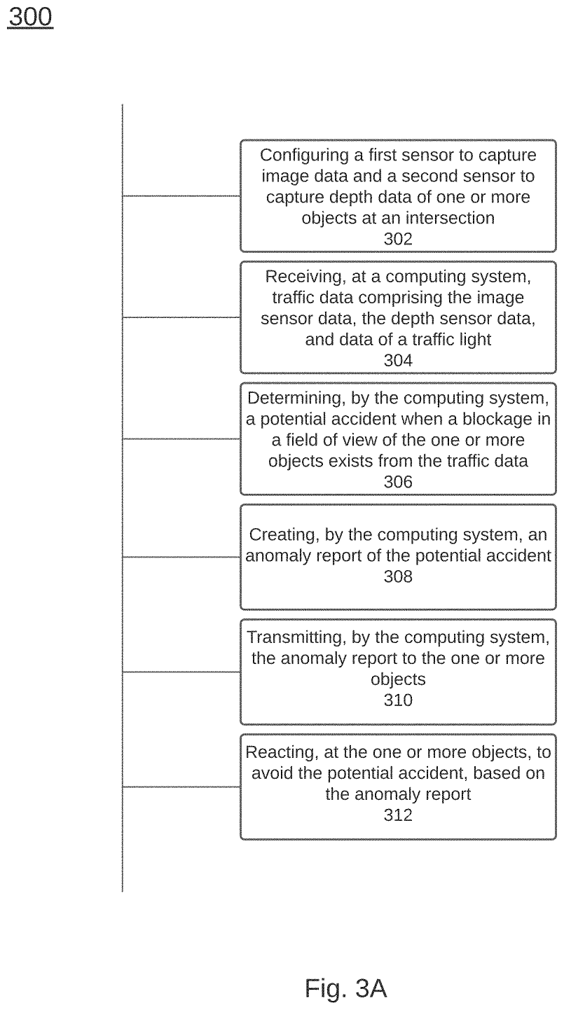

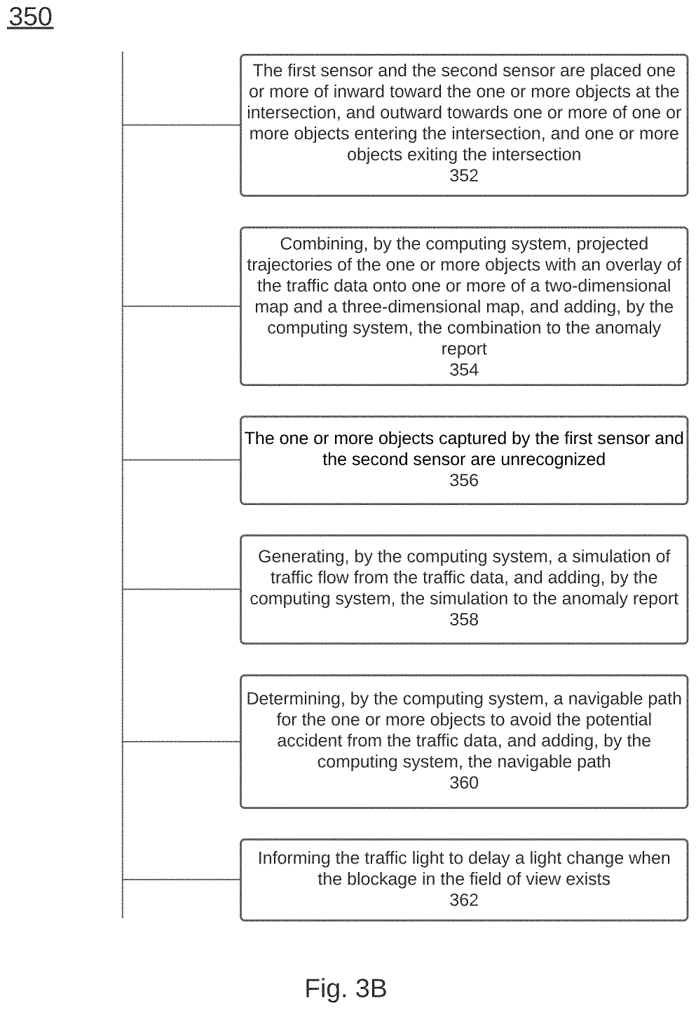

FIG. 3A illustrates a flow diagram 300, according to example embodiments. Referring to FIG. 3A, the solution comprises one or more of configuring a first sensor to capture image data and a second sensor to capture depth data of one or more objects at an intersection 302, receiving, at a computing system, traffic data comprising the image sensor data, the depth sensor data, and data of a traffic light 304, determining, by the computing system, a potential accident when a blockage in a field of view of the one or more objects exists from the traffic data 306, creating, by the computing system, an anomaly report of the potential accident 308, transmitting, by the computing system, the anomaly report to the one or more objects 310, and reacting, at the one or more objects, to avoid the potential accident, based on the anomaly report 312.

FIG. 3B illustrates a flow diagram 350, according to example embodiments. Referring to FIG. 3B, the solution comprises one or more of the first sensor and the second sensor are placed one or more of inward toward the one or more objects at the intersection, and outward towards one or more of one or more objects entering the intersection, and one or more objects exiting the intersection 352, combining, by the computing system, projected trajectories of the one or more objects with an overlay of the traffic data onto one or more of a two-dimensional map and a three-dimensional map, and adding, by the computing system, the combination to the anomaly report 354, the one or more objects captured by the first sensor and the second sensor are unrecognized 356, generating, by the computing system, a simulation of traffic flow from the traffic data, and adding, by the computing system, the simulation to the anomaly report 358, determining, by the computing system, a navigable path for the one or more objects to avoid the potential accident from the traffic data, and adding, by the computing system, the navigable path 360, and, informing the traffic light to delay a light change when the blockage in the field of view exists 362.

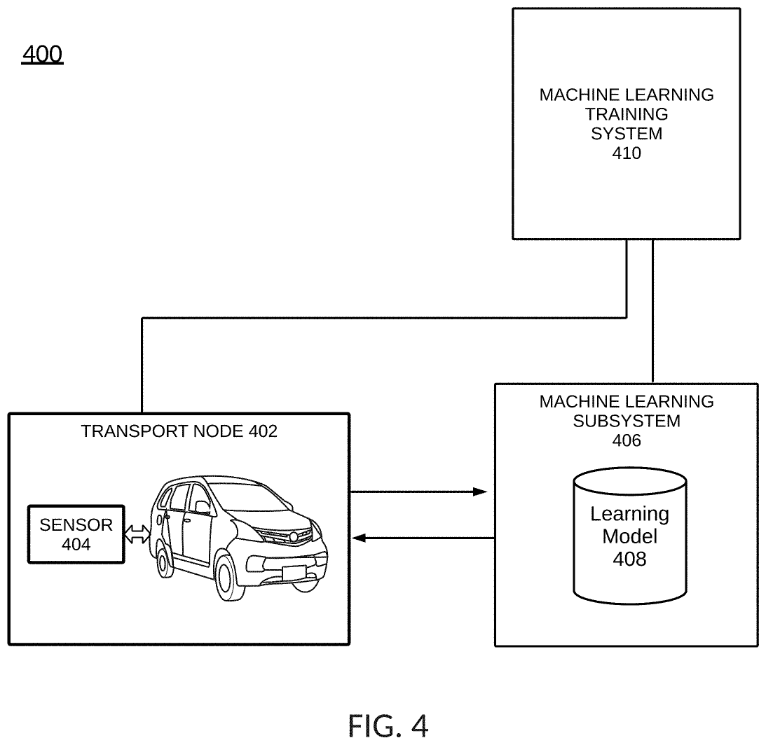

FIG. 4 illustrates a machine learning transport network diagram 400, according to example embodiments. The network 400 includes a transport 402 that interfaces with a machine learning subsystem 406. The transport includes one or more sensors 404.

The machine learning subsystem 406 contains a learning model 408, which is a mathematical artifact created by a machine learning training system 410 that generates predictions by finding patterns in one or more training data sets. In some embodiments, the machine learning subsystem 406 resides in the transport 402. In other embodiments, the machine learning subsystem 406 resides outside of the transport 402, such as in the computing device 116.

The transport 402 sends data from the one or more sensors 404 to the machine learning subsystem 406. The machine learning subsystem 406 provides the one or more sensor 404 data to the learning model 408, which returns one or more predictions. The machine learning subsystem 406 sends one or more instructions to the transport 402 based on the predictions from the learning model 408.

In a further example, the transport 402 may send the one or more sensor 404 data to the machine learning training system 410. In yet another embodiment, the machine learning subsystem 406 may sent the sensor 404 data to the machine learning subsystem 410. One or more of the applications, features, steps, solutions, etc., described and/or depicted herein may utilize the machine learning network 400 as described herein.

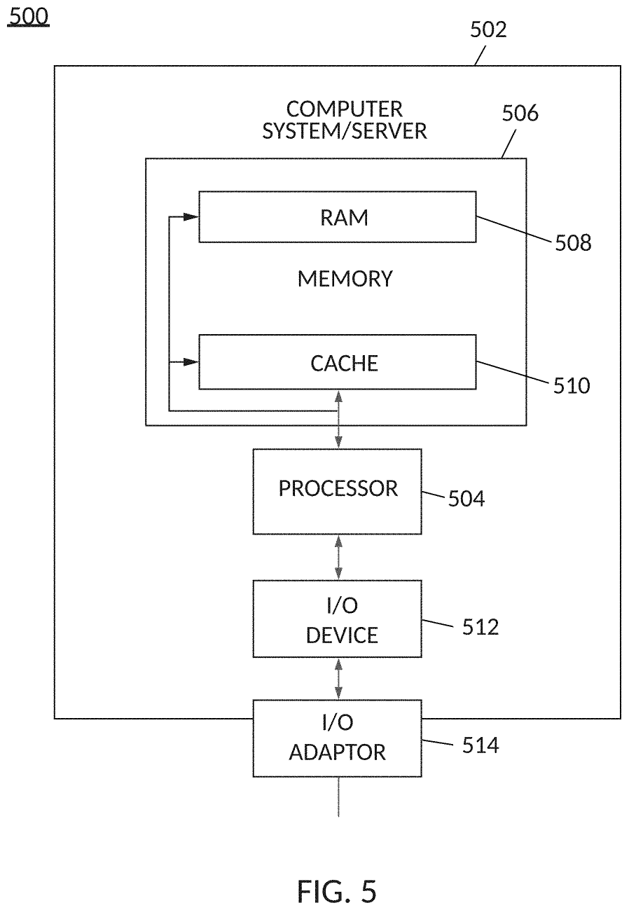

FIG. 5 is not intended to suggest any limitation as to the scope of use or functionality of embodiments of the application described herein. Regardless, the computing node 500 is capable of being implemented and/or performing any of the functionality set forth hereinabove.

In computing node 500 there is a computer system/server 502, which is operational with numerous other general purpose or special purpose computing system environments or configurations. Examples of well-known computing systems, environments, and/or configurations that may be suitable for use with computer system/server 502 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 502 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 502 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 5, computer system/server 502 in cloud computing node 500 is shown in the form of a general-purpose computing device. The components of computer system/server 502 may include, but are not limited to, one or more processors or processing units 504, a system memory 506, and a bus that couples various system components including system memory 506 to processor 504.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 502 typically includes a variety of computer system readable media. Such media may be any available media that is accessible by computer system/server 502, and it includes both volatile and non-volatile media, removable and non-removable media. System memory 506, in one embodiment, implements the flow diagrams of the other figures. The system memory 506 can include computer system readable media in the form of volatile memory, such as random-access memory (RAM) 508 and/or cache memory 510. Computer system/server 502 may further include other removable/non-removable, volatile/non-volatile computer system storage media. By way of example only, memory 506 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus by one or more data media interfaces. As will be further depicted and described below, memory 506 may include at least one program product having a set (e.g., at least one) of program modules that are configured to carry out the functions of various embodiments of the application.

Program/utility, having a set (at least one) of program modules, may be stored in memory 506 by way of example, and not limitation, as well as an operating system, one or more application programs, other program modules, and program data. Each of the operating system, one or more application programs, other program modules, and program data or some combination thereof, may include an implementation of a networking environment. Program modules generally carry out the functions and/or methodologies of various embodiments of the application as described herein.

As will be appreciated by one skilled in the art, aspects of the present application may be embodied as a system, method, or computer program product. Accordingly, aspects of the present application may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present application may take the form of a computer program product embodied in one or more computer readable medium(s) having computer readable program code embodied thereon.

Computer system/server 502 may also communicate with one or more external devices via a I/O adapter 514, such as a keyboard, a pointing device, a display, etc.; one or more devices that enable a user to interact with computer system/server 502; and/or any devices (e.g., network card, modem, etc.) that enable computer system/server 502 to communicate with one or more other computing devices. Such communication can occur via I/O interfaces of the adapter 514. Still yet, computer system/server 502 can communicate with one or more networks such as a local area network (LAN), a general wide area network (WAN), and/or a public network (e.g., the Internet) via network adapter. As depicted, adapter 514 communicates with the other components of computer system/server 502 via a bus. It should be understood that although not shown, other hardware and/or software components could be used in conjunction with computer system/server 502. Examples, include, but are not limited to: microcode, device drivers, redundant processing units, external disk drive arrays, RAID systems, tape drives, and data archival storage systems, etc.

Although an exemplary embodiment of at least one of a system, method, and non-transitory computer readable medium has been illustrated in the accompanied drawings and described in the foregoing detailed description, it will be understood that the application is not limited to the embodiments disclosed, but is capable of numerous rearrangements, modifications, and substitutions as set forth and defined by the following claims. For example, the capabilities of the system of the various figures can be performed by one or more of the modules or components described herein or in a distributed architecture and may include a transmitter, receiver or pair of both. For example, all or part of the functionality performed by the individual modules, may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via plurality of protocols. Also, the messages sent or received by any of the modules may be sent or received directly and/or via one or more of the other modules.

One skilled in the art will appreciate that a “system” could be embodied as a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present application in any way but is intended to provide one example of many embodiments. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above may be practiced with steps in a different order, and/or with hardware elements in configurations that are different than those which are disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

What is claimed is:

1. A method, comprising:
configuring a first sensor to capture image data and a second sensor to capture depth data of one or more objects at an intersection;
receiving, at a computing system, traffic data comprising the image sensor data, the depth sensor data, and data of a traffic light;
determining, by the computing system, a potential accident when a blockage in a field of view of the one or more objects exists from the traffic data;
creating, by the computing system, an anomaly report of the potential accident;
transmitting, by the computing system, the anomaly report to the one or more objects; and
reacting, at the one or more objects, to avoid the potential accident, based on the anomaly report.

2. The method of claim 1, wherein the first sensor and the second sensor are placed one or more of inward toward the one or more objects at the intersection; and outward towards one or more of one or more objects entering the intersection; and one or more objects exiting the intersection.

3. The method of claim 1, comprising:
combining, by the computing system, projected trajectories of the one or more objects with an overlay of the traffic data onto one or more of a two-dimensional map and a three-dimensional map; and
adding, by the computing system, the combination to the anomaly report.

4. The method of claim 1, wherein the one or more objects captured by the first sensor and the second sensor are unrecognized.

5. The method of claim 1, comprising:
generating, by the computing system, a simulation of traffic flow from the traffic data; and
adding, by the computing system, the simulation to the anomaly report.

6. The method of claim 1, comprising:
determining, by the computing system, a navigable path for the one or more objects to avoid the potential accident from the traffic data; and
adding, by the computing system, the navigable path.

7. The method of claim 1, comprising, when the blockage in the field of view exists, informing the traffic light to delay a light change.

8. A system, comprising:
a processor and memory communicably coupled to the processor, wherein the processor is configured to perform:
configure a first sensor to capture image data and a second sensor to capture depth data of one or more objects at an intersection;
receive, at a computing system, traffic data that comprises the image sensor data, the depth sensor data, and data of a traffic light;
determine, by the computing system, a potential accident when a blockage in a field of view of the one or more objects exists from the traffic data;
create, by the computing system, an anomaly report of the potential accident;
transmit, by the computing system, the anomaly report to the one or more objects; and
react, at the one or more objects, to avoid the potential accident, based on the anomaly report.

9. The system of claim 8, wherein the first sensor and the second sensor are placed one or more of inward toward the one or more objects at the intersection; and outward towards one or more of one or more objects that enters the intersection; and one or more objects that exits the intersection.

10. The system of claim 8, comprising:
combine, by the computing system, projected trajectories of the one or more objects with an overlay of the traffic data onto one or more of a two-dimensional map and a three-dimensional map; and
add, by the computing system, the combination to the anomaly report.

11. The system of claim 8, wherein the one or more objects captured by the first sensor and the second sensor are unrecognized.

12. The system of claim 8, comprising:
generate, by the computing system, a simulation of traffic flow from the traffic data; and
add, by the computing system, the simulation to the anomaly report.

13. The system of claim 8, comprising:
determine, by the computing system, a navigable path for the one or more objects to avoid the potential accident from the traffic data; and
add, by the computing system, the navigable path.

14. The system of claim 8, comprising, when the blockage in the field of view exists, inform the traffic light to delay a light change.

15. A non-transitory computer readable medium comprising instructions, that when read by a processor, cause the processor to perform:
configuring a first sensor to capture image data and a second sensor to capture depth data of one or more objects at an intersection;
receiving, at a computing system, traffic data comprising the image sensor data, the depth sensor data, and data of a traffic light;
determining, by the computing system, a potential accident when a blockage in a field of view of the one or more objects exists from the traffic data;
creating, by the computing system, an anomaly report of the potential accident;
transmitting, by the computing system, the anomaly report to the one or more objects; and
reacting, at the one or more objects, to avoid the potential accident, based on the anomaly report.

16. The non-transitory computer readable medium of claim 15, wherein the first sensor and the second sensor are placed one or more of inward toward the one or more objects at the intersection; and outward towards one or more of one or more objects entering the intersection; and one or more objects exiting the intersection.

17. The non-transitory computer readable medium of claim 15, comprising:
combining, by the computing system, projected trajectories of the one or more objects with an overlay of the traffic data onto one or more of a two-dimensional map and a three-dimensional map; and
adding, by the computing system, the combination to the anomaly report.

18. The non-transitory computer readable medium of claim 15, comprising:
generating, by the computing system, a simulation of traffic flow from the traffic data; and
adding, by the computing system, the simulation to the anomaly report.

19. The non-transitory computer readable medium of claim 15, comprising:
determining, by the computing system, a navigable path for the one or more objects to avoid the potential accident from the traffic data; and
adding, by the computing system, the navigable path.

20. The non-transitory computer readable medium of claim 15, comprising, when the blockage in the field of view exists, informing the traffic light to delay a light change.
